(19) United States
(12) Patent Application Publication
(10) Pub. No.: US 2008/0249993 A1
(43) Pub. Date: Oct. 9, 2008

(54) System And Method For Localized Social Network

(76) Inventor: Steven M. Rayner, Little Elm, TX (US)

Correspondence Address: PERKINS COIE LLP, P.O. BOX 1208, SEATTLE, WA, 98111-1208, US

(21) Appl. No.: 11/864,965

(22) Filed: Sep. 29, 2007

Related U.S. Application Data
(60) Provisional application No. 60/849,275, filed on Oct. 3, 2006.

(51) Int. Cl. G06F 7/06; G06F 17/00; G06F 17/30

(52) U.S. Cl. 707/3; 235/375; 707/104.1; 707/E17.014; 707/E17.044

(57) ABSTRACT

Systems and methods are provided to localize a social network. A VIP card may be used to connect businesses and users. Multiple user types may be specified. Features and functionality associated with multiple users may be specified.

### RELATED APPLICATIONS

This application claims priority to U.S. Provisional Patent Application No. 60/849,275, filed Oct. 3, 2006, and entitled “System and Method for Localized Social Network” by Steven M. Rayner, which is incorporated by reference.

### BACKGROUND

Online Social Networks (OSNs) may include users who create connections to other network users. OSNs may allow users to communicate with others and to meet new friends through their current connections. In some OSNs, a user can may photos, music, video, clips, announcement, blogs, and links. Other users can view these postings and if desired, contact the user posting the material.

Online City Directories (OCDs) may allow users to find and rate different locations such as restaurants, bars, museums, etc. Users can read other's reviews about their experiences at a particular location. Some OCDs provide links to a location's webpage for further information.

The foregoing examples of the related art and limitations related therewith are intended to be illustrative and not exclusive. Other limitations of the related art will become apparent to those of skill in the art upon a reading of the specification and a study of the drawings.

### SUMMARY

The following examples and aspects thereof are described and illustrated in conjunction with systems, tools, and methods that are meant to be exemplary and illustrative, not limiting in scope. In some of the examples, one or more of the above described problems has been reduced or eliminated, while other examples are directed to other improvements.

Localization focuses a user's experience may provide flexibility in offering services. Search tools are provided which allow a user to focus a search in a geographic area and to provide businesses who are offering special incentives or special events. Members may participate in Member-to-Member (M2M) transactions, reviews, blogs, electronic invitations, posts, photo sharing, personal profiles, event suggestions and schedule sharing and any other known or convenient member activity.

Merchants may be selected to participate in the network. Selected merchants may advertise and provide incentives only available to members. Selected merchants may choose to advertise and promote using the network. Advantageously, high quality merchants may be provided members. A VIP card may or may not be included to identify a member with a business. A VIP card may provide benefits to the user such as greater discounts and benefits to the partners who can now track profits created by promotions using the network.

The network may allow members to build a sense of community through ongoing input and surveys. The network allows users to share benefits among members. Advantageously, a sense of community has been shown to increase customer retention and satisfaction.

These and other advantages will become apparent to those skilled in the art upon a reading of the following descriptions and a study of the several figures of the drawings.

### BRIEF DESCRIPTION

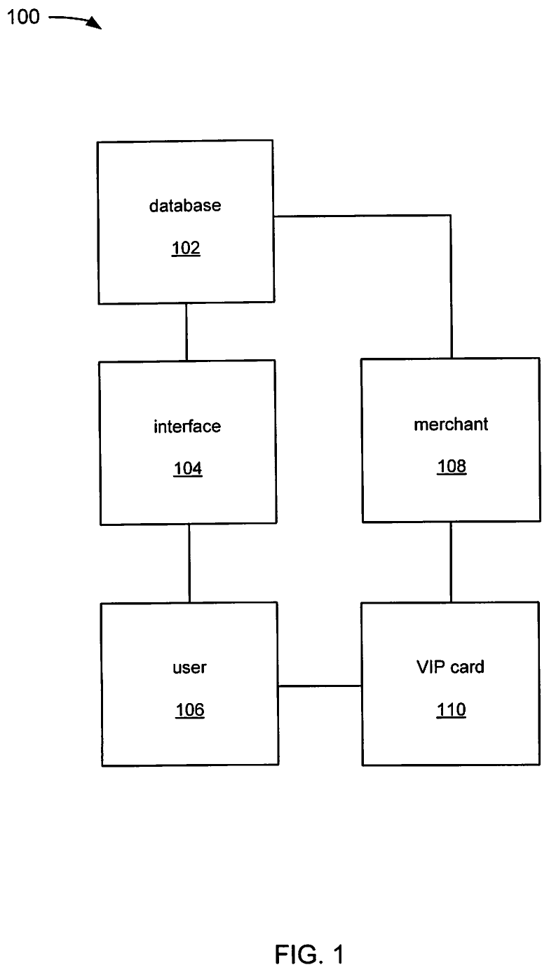

FIG. 1 depicts an example of a system for implementing a localized social network.

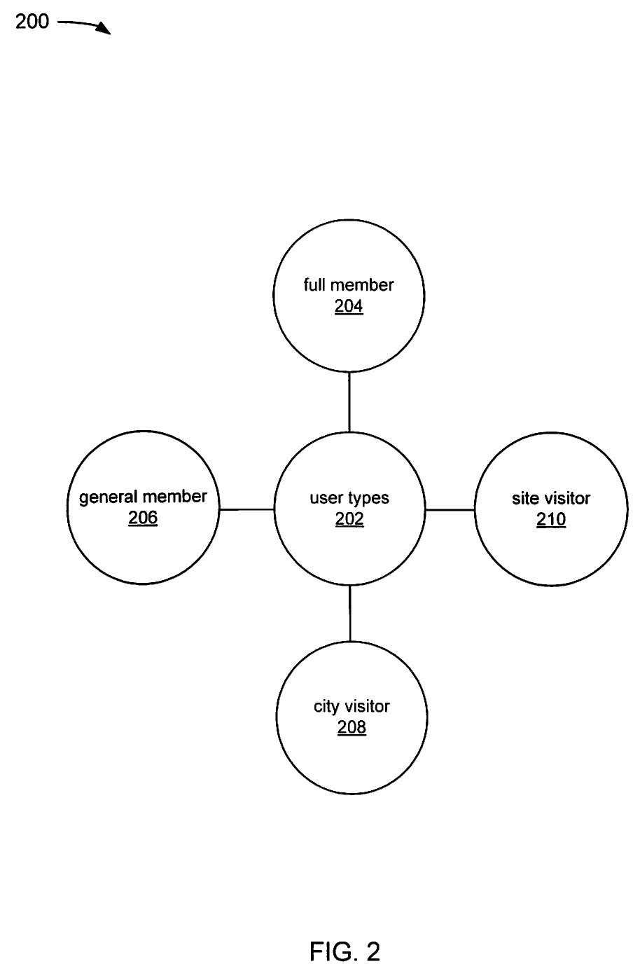

FIG. 2 depicts a diagram of an example of user types.

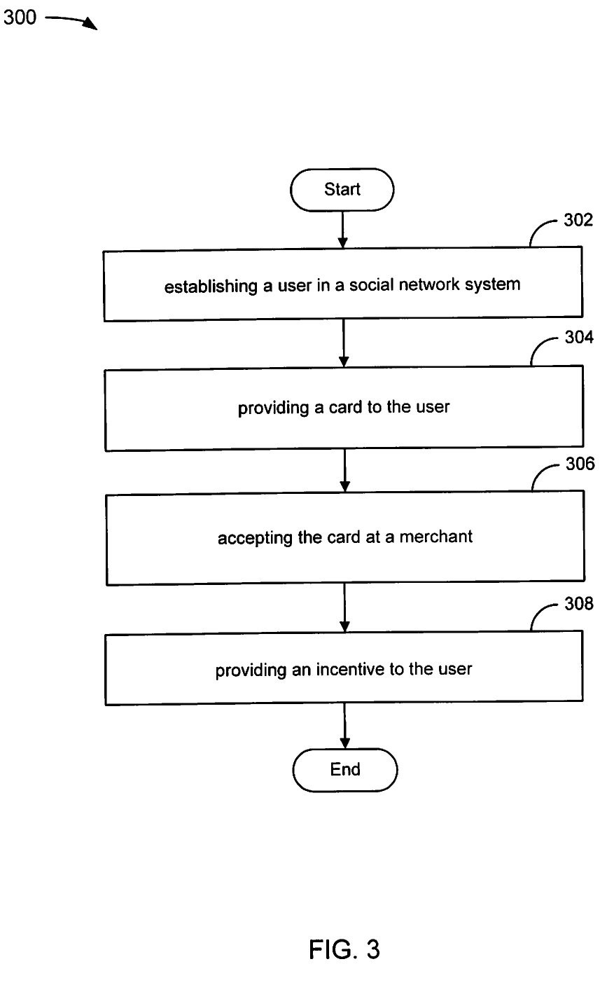

FIG. 3 depicts an example of a flowchart of a method for providing an incentive to a user.

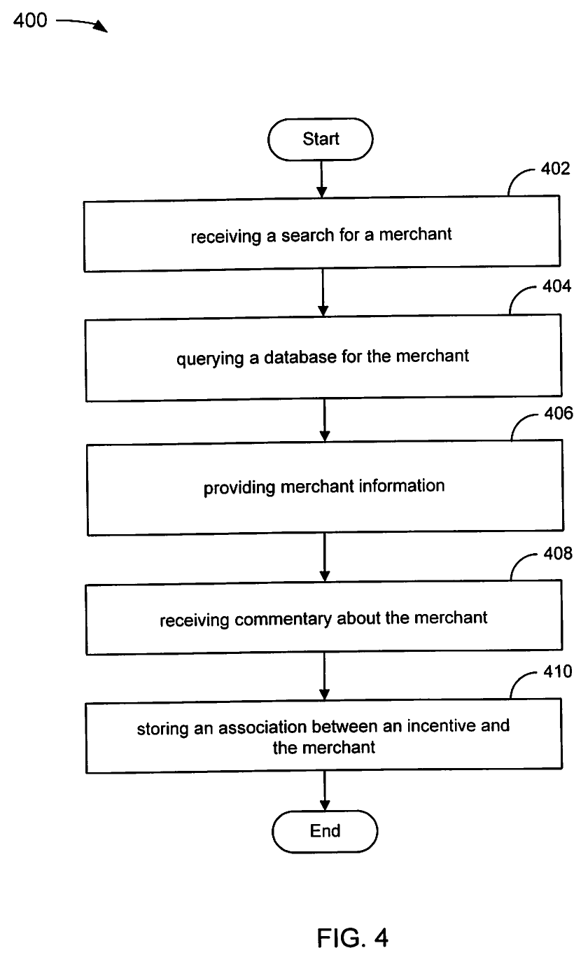

FIG. 4 depicts an example of a flowchart of a method for associating an incentive with commentary about a merchant.

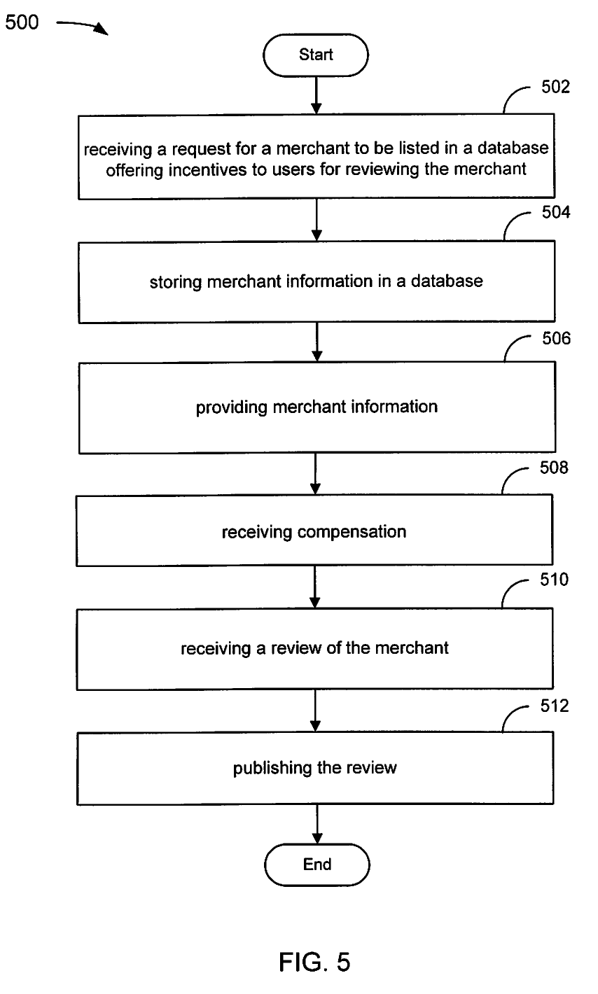

FIG. 5 depicts an example of a flowchart of a method for monetizing a revenue stream.

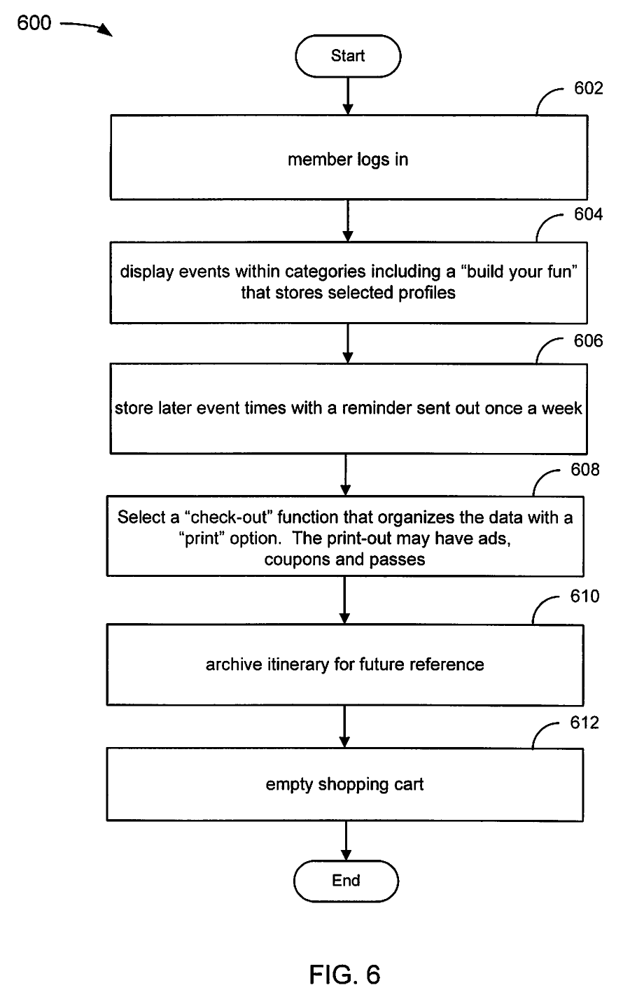

FIG. 6 depicts an example of a flowchart of a “Build Your Fun” feature.

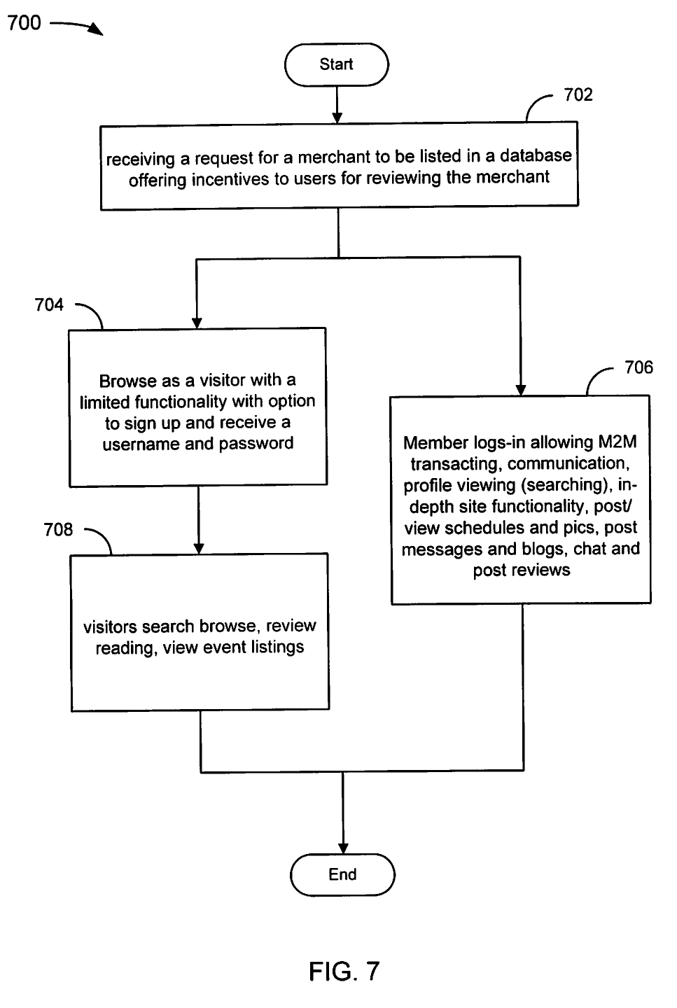

FIG. 7 depicts an example of a flowchart of a system for implementing a localized social network.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

FIG. 1 depicts an example of a system for implementing a localized social network. FIG. 1 includes database 102, interface 104, user 106, merchant 108, and VIP card 110.

In the example of FIG. 1, the database 102 may include functionality to store data associated with the system. Data about merchants may be stored. Database 102 may be a conventional database, a file, or any known or convenient manner of storing data.

In the example of FIG. 1, the interface 104 may include various functionality to provide searching of the database. A Localized Business/Partner Search may be performed. A search field may implement a search. In the search field a user may indicate whether they wish to search by neighborhood, category, A List Privileges, events, or a combination of the preceding. Various drop down boxes and buttons may be used to implement choices. Visitors may search by category view general listings. A List VIP listings category may be specified.

In the example of FIG. 1, the user 106 may be a user of one or more types. User 106 may be of a user type as discussed in reference to FIG. 2, including full member, general member, site visitor, or city visitor.

In the example of FIG. 1, the merchant 108 may be any commercial establishment, business, business partner, or other entity. The merchant 108 may be associated with one or more users.

In the example of FIG. 1, the VIP card 110 may include an ID number, bar code, or magnetic strip which allows the person's identity to be verified. Tracking of a user may provide benefits to both the user and the merchant. A merchant may be able to determine which users have attended certain events and offer incentives to these users. The VIP card may include a photograph of the user for identification. The VIP card 110 may include a line of credit, either offered by or sponsored by the system. The VIP card 110 may be able to track purchases at a particular partner and use this information to provide benefits targeted at their particular tastes. Partners or the system may also provide benefits for spending a certain amount or buying a certain number of products. In a non-limiting example, if a user drinks margaritas at a partner event she may be notified afterwards of other partners offering drink specials on margaritas. In a non-limiting example, a partner could offer a free burrito for purchasing 10 burritos; the user's purchases may be automatically tracked.

### Localized Search

A Localized Person Search may be performed. In a web implementation, a user may activate a drop down search box and/or search field. In the search field the user may indicate whether she wishes to search by age or range, group affiliation, “A List” group, relationship status, zip code, zip code radius, interests, professional status, profession, pictures, reason for being here, name, email, display name, common A List friends, keyword, or any category known or convenient.

Data points may be associated with business assessments. Data points may include member reviews, message board postings requesting info, A List privileges, geography, parking, or any combination of known or convenient data points.

The system may provide localization of search information by providing additional relevant information. In a non-limiting example, if “That restaurant” is entered as a search term the system may return nearby That restaurants. If the user selects a particular restaurant additional information associated with the restaurant may be given for the user. A list of nearby merchants which could be visited before or after eating at the That restaurant could be returned. Suggestions may be generated many ways. Association between the restaurant and the user profile may be used. Recommendations by other members may be used. In a non-limiting example, a suggestion may be a movie and a time given relative to the time of a reservation made at a restaurant. In addition, a restaurant associated with desert or drinks could be suggested as a possible business to patronize after the movie ends.

The system may also provide automatic construction of social events. A user could enter the type of event desired, such as “romantic date”, and any general parameters such as day, time, or any other known or convenient parameters. The system could then construct the “romantic date” automatically, and if possible make any reservations necessary. In a non-limiting example, the system could automatically make reservations online for dinner and then purchase tickets to an opera.

A user's profile may influence where and what is chosen. Users may submit plans on social events, such as a sequence of locations that would be visited as a date. A user may review suggestions and select one. Suggestions may be recommendations for a single location or event, or they may be compound suggestions with multiple locations suggested, for example a place for dinner, then a movie, and then a good drink location.

### User Reviews

An incentive plan may be offered to users for the user's on-going reviews. Different incentives could be offered depending on which partner business was reviewed, the business category of the partner business, thoroughness of the review, quality of the review, or number of previously entered reviews of the business.

A user may use a Rating System/Reviewing System. A user may describe his occasion for going out, a time of arrival, whether guests accompanied, a name of a server, what food was ordered, if any. A 1-10 rating scale could be implemented providing 1 as the lowest value, and 10 as the highest value.

Service 1-10 (brief description)

Experience 1-10 (brief description)

Quality 1-10 (brief description)

Timely 1-10 (brief description)

Environment 1-10 (brief description)

Staff 1-10 (brief description)

Would you go back? Yes/No (brief description)

Would you recommend this to your friends? Yes/No (brief description)

A system may put together a brief member review summary and a rating number based on an average of many members' choices. The user may have options for rating the restaurant. The review may be tailored to the user. The user could limit accessibility of the review to other users they are connected to, or she could limit it to a user which has been flagged.

### Build Your Fun

The goal for this feature/functionality is to allow users to be able to add/save events, venues, businesses, privileges, directions, dress codes, ages, surrounding area, movie listings, reservation times and various other information into a shopping cart feature. The information may be printed out and brought with the user.

### Event Information

The system may recommend certain events based on the user's preferences. For example, the system may track how many people have signed up to attend an event. From this information and user profile data, recommendation may be made to other users to attend the event considering the profiles of people planning to attend. As an example, if a male user was interested in meeting single women the system could notify him of events with a large number of single women, or where there are more single women attending then men. Notifications could be tracked in real time using the information from a user's VIP card. This could provide the user up to date information on the status of events in and around a city.

A user may be able to track individuals at a particular location. The VIP card of a user could be scanned and another user could be notified the user has arrived. Arrival information may be limited to those connected to the user or customizable by the user. A user could be notified through a text message to a phone.

Messaging & Location based Messaging

The system may have integrated mobile phone messaging, such as SMS messaging. Messages may be used to advertise. In a non-limiting example, a partner night club may experience a low volume of business on a given night and could send out messages advertising drink specials.

The system may allow a user access to the itinerary of friends in her network. A message could be forwarded to the user's cell phone to notify the user of arrival of one or more friends. The VIP card of the friend could be tracked for this purpose. Advantageously, a social event could be more easily coordinated. GPS location information could be integrated into the system. There, the system could send notifications to the user when a user is near a partner business, and can also give information on any specials or incentives at the partner business.

FIG. 2 depicts a diagram 200 of an example of user types. The diagram 200 includes the full member 204, general member 206, city visitors 208, and site visitors 210. The user types are given by of example and not limitation.

In the example of FIG. 2, the full member 204 may have access to all site functionality and community search features and receives a VIP card to identify themselves at participating partners. The full member 204 may be given special benefits in the community. The full member's reviews of different events or merchants may be given precedence in rating a merchant. A full member's reviews may be listed first for a particular merchant. Full member 204 may have input used for selecting merchants to join the system. A full member may be able to develop “points” which can be used to purchase incentive, such as the benefits listed above. Full members may also be give special benefits by merchants such as reduced cost items, free items, reduced or no entrance fees, precedence in selecting ticket location, use of VIP rooms, immediate entrance instead of waiting in line, shuttle service, free cab fair, validation of parking, or any other benefit known or convenient.

Full member 204 may have full member status granted for a variety of reasons such as paying an initiation fee, paying a regular fee, being rated highly by other members, providing reviews of merchants, serving on a “street team” by assisting in advertising for the system or a businesses, and encouraging others to become members. Temporary passes into full member status may also be given for any of the previously stated reasons. The full member is also issued a VIP card which can be used at partner events to identify the member, the VIP card is discussed in depth below.

In the example of FIG. 2, the general member 206 may receive email newsletter, event invites and local search capabilities. The general member 206 may be given some benefits of the community such as a newsletter, event invites, and local search capability but may not have access to other benefits given to full members. The general member 206 may not be given a VIP card to identify himself at business locations. The general member 206 may be given a VIP card but the VIP card may be of a different type than full member 204 and may provide a lesser level of benefits. The general member 206 may accrue points which can be used to purchase incentives. Points may accrue at a slower rate for the general member 206 than for full member 204.

A user may be made the general member 206 as a result of any of the actions described above in reference to full member 204, but requirements may be lower. In a non-limiting example, a fee may be paid to join as a general member, but a lower fee may be required for the full member 204. In an additional example, the full member 204 may agree to fill out a certain number of surveys to maintain the general member 206 status. In a non-limiting example, the general member status may be granted by filling out profile information which can be provided to partner businesses.

In the example of FIG. 2, the city visitor 208 may be provided a temporary pass for the duration of their stay in a particular city. A user visiting a city may register with the system and be provided with the benefits of the full member 204 or the general member 206. The user may be new to the system or may be a member of the system in a different city. In some examples, the city visitor 208 may be granted exclusive rights to a particular group. The city visitor 208 may be granted city visitor status as a benefit of being a member of the system in a different city. The user may be granted city visitor status for paying a fee. In a non-limiting example, a business that caters to tourists could offer special discounts to members of the city visitor 208 type. Some user types may be excluded from particular offers.

In the example of FIG. 2, the site visitor 210 may be a user who anonymously or without signing in, uses the basic functionality of the system. The site visitor 210 may access a local search function for free. The site visitor 210 may have access to basic search functions of the system. The site visitor 210 may be allowed to use some functionality without investing much time or any money. The site user 210 may search for a business and the site user 210 may also receive information about the incentives offered to full members, general members, and city visitors.

The system may also provide for other combinations of different user types. A user may be interested in only a certain subset of the partner businesses and may wish to only be provided with benefits for this subset. For these types of users specialized types can be created, such as a “clubber member” for those who like night clubs, a “diner member” for those only interested in restaurants, a “fine art member” for those interested in museum and other fine arts institutions, or any other member type or combination known or convenient. User types may be defined by age group or affiliation with a particular institution.

A user may also be granted the status of organizer. The user having organizer status may be contacted directly by partners to set up a social event. The user having organizer status may post social events. Partners may bid on social events; the user having organizer status may select a partner offering the best benefits.

FIG. 3 depicts an example of a flowchart of a method 300 for providing an incentive to a user. However, it should be understood that these and modules associated with other methods described herein may be reordered for parallel execution or into different sequences of modules.

FIG. 4 depicts an example of a flowchart of a method 400 for associating an incentive with commentary about a merchant. However, it should be understood that these and modules associated with other methods described herein may be reordered for parallel execution or into different sequences of modules.

FIG. 5 depicts an example of a flowchart 500 of a method for monetizing a revenue stream. However, it should be understood that these and modules associated with other methods described herein may be reordered for parallel execution or into different sequences of modules.

Merchants may pay to advertise. A business may advertise passively by banners, pop-up ads, or any other advertisements known or convenient. Advertising may be restricted to allow only selected businesses to advertise. Business may be mentioned in a newsletter, and may notify users of upcoming events through the system messenger system. A user may receive compensation for reviewing a merchant. A user may receive compensation for reviewing the merchant on a per-review basis. The reviews may be published for other members to read.

The system may derive revenue by charging a fee to users. An initiation fee may be required by full or general members to join. The system may charge a fee to replace lost or stolen VIP cards. A fee may be charged to allow users to sell products to other members. The system may also derive revenue through the sale of retail merchandise. The VIP card may have an associated line of credit. The associated line of credit may be used to track purchases. These may include products which are useful while using the site such as webcams, headphones or branded items such as promotional apparel.

FIG. 6 depicts an example of a flowchart 600 of a “Build Your Fun” feature. However, it should be understood that these and modules associated with other methods described herein may be reordered for parallel execution or into different sequences of modules.

In the example of FIG. 6, the flowchart being with block 602. In block 602, a member logs-in to the network. The user may log in by entering a user name and password, or any other log-in method known or convenient. In block 604, the member approaches listings with events within categories, and there may be a button “build your fun” that stores that selected profile. In block 606, information may be stored for a later time and a reminder sent regularly. In block 608, the member may automatically select a “check-out” function that organizes the data with a “print” option. The print-out may have ads, coupons and passes. In block 610, an itinerary may be archived for future reference. In block 612, a shopping cart may be emptied of the previously stored information.

The “Build Your Fun” features may be limited by user type as discussed in reference to FIG. 2. A full member may have all features while a general member may have access to fewer features. The coupons and passes given may be sensitive to the profile information of the user. In a non-limiting example, drink coupons could be provided in reference to the drinks the user prefers.

FIG. 7 depicts an example of a flowchart 700 of a system for implementing a localized social network. However, it should be understood that these and modules associated with other methods described herein may be reordered for parallel execution or into different sequences of modules. In block 702, a member logs-in to the network. The user may log in by entering a user name and password, or any other log-in method known or convenient.

In block 702, a user may enter a universal resource locator (URL) corresponding to a city or geographic region, or other known or convenient manner of identifying a group of people.

In block 704, once the user arrives to a designated city site, she can browse as a visitor with limited functionality and they have the option to sign-up and receive a username and password.

In block 706, the system allows for member-to-member transactions, communication, profile viewing (searching), and in-depth site functionality; “Build your Fun!” may be provided. A user may also send electronic invitations, post/view schedules and pictures, post messages and blogs, chat and post specific reviews.

In block 708, visitors may use a URL to search. Visitors may not need to sign-up for a password and username. The visitor may be allowed to browse/search, review, and obtain event listings.

It will be appreciated to those skilled in the art that the preceding examples are not limiting in scope. It is intended that all permutations, enhancements, equivalents, and improvements thereto that are apparent to those skilled in the art upon a reading of the specification and a study of the drawings are included within the true spirit and scope of these teachings. It is therefore intended that the following appended claims include all such modifications, permutations, and equivalents as fall within the true spirit and scope of these teachings.

What is claimed is:

1. A system comprising:
an interface including options for searches of merchants; and
a database including merchant information associated with the interface; and
a card associated with the interface;
wherein, in operation, the interface allows a user to search the database and provides identifying information of a merchant and the card may be used to obtain an incentive offered by the merchant.

2. The system of claim 1 further comprising user preferences including search criteria;
wherein, in operation, the search criteria are used to narrow a search for merchants in an area.

3. The system of claim 1 wherein a newsletter is generated and provided to the user including event invitations.

4. The system of claim 1 further comprising a classification identifier, wherein the classification identifier is one of a full member, a general member, a city visitor, or a site visitor.

5. The system of claim 1 further comprising providing a suggestion to the user of a merchant by considering a profile of the user.

6. A method for providing incentives comprising:
establishing a user in a social network system;
providing a card to the user;
accepting the card at a merchant; and
providing an incentive to the user.

7. The method of claim 1 further comprising:
transmitting a printable coupon of the incentive to the user.

8. The method of claim 1 further comprising:
receiving a search from the user for the merchant; and
providing information about the merchant to the user.

9. The method of claim 1 wherein the card has an associated line of credit, and purchases with the merchant may be used to provide an incentive to the user.

10. A system comprising:
an interface including options for searches of merchants; and
a database including merchant information associated with the interface; and
wherein, in operation, the interface allows a user to search the database for merchants in the area to provide comments and the comments are recorded and associated with incentives from the merchants for the user.

11. The system of claim 1 wherein the user has a status of organizer, and the user may additionally allow the merchant to directly contact the user in planning a social event.

12. The system of claim 1 wherein a point is assigned to the user for providing comments.

13. A method comprising:
receiving a search for a merchant;
querying a database for the merchant;
providing merchant information;
receiving commentary about the merchant; and
storing an association between an incentive and the merchant.

14. The method of claim 13 further comprising accounting for the association by adding a point to an account stored in the database.

15. The method of claim 13 wherein an anonymous user provides the search for the merchant, and an incentive is provided to the anonymous user to become a registered user.

16. The method of claim 13 wherein the search is a localized search made by geographic area.

17. A method for monetizing a revenue stream comprising:
receiving a request for a merchant to be listed in a database offering incentives to users for reviewing the merchant;
storing merchant information in a database;
providing merchant information;
receiving compensation;
receiving a review of the merchant; and
publishing the review.

18. The method of claim 17 wherein the compensation is received after a user has reviewed a merchant.

19. The method of claim 17 wherein the compensation is received on a per-review basis.

20. The method of claim 17 wherein charges to a card having an associated line of credit are automatically used to track purchases with the merchant.
